(19) United States
(12) Patent Application Publication
(10) Pub. No.: US 2025/0116407 A1
(43) Pub. Date: Apr. 10, 2025

(54) OUTDOOR BURNERS

(71) Applicant: Boil Boss, L.L.C., Harahan, LA (US)

(72) Inventors: Robert T. Lapeyre, New Orleans, LA (US); Robert S. Lapeyre, New Orleans, LA (US)

(21) Appl. No.: 18/908,275

(22) Filed: Oct. 7, 2024

Related U.S. Application Data
(60) Provisional application No. 63/543,195, filed on Oct. 9, 2023.

(51) Int. Cl. F24C 3/08; A47J 37/07

(52) U.S. Cl. CPC F24C 3/08; A47J 37/0763

(57) ABSTRACT

An outdoor burner and a burner assembly characterized by a single jet tube or multiple jet tubes spaced apart from each other away from the middle of the bottom of a pot centered on the burner's pot-support surface. Centering brackets are used to center pots on the burner. Electronic ignition is used to ignite the burner. Obliquely arranged nozzles away from the center of the jet tube inject gas into the tubes with minimal blockage of air flow to aid complete combustion and hotter flames. The burner can be adapted to provide low-pressure cooking or high-pressure cooking.

### CROSS-REFERENCE TO RELATED APPLICATIONS

This application claims the benefit of co-pending U.S. Provisional Patent Application No. 63/543,195, filed Oct. 9, 2023.

### TECHNICAL FIELD

The invention relates generally to outdoor burners and, more particularly, to outdoor burners for supporting and heating large pots.

### BACKGROUND

Outdoor cooking stands of the jet-burner type are often used to support and heat large pots in which, for example, seafood is boiled, poultry is fried, or beer is brewed. Typical outdoor burners comprise a pot-supporting stand with a jet tube directing a flame at high pressure upward against the bottom of a supported pot. The jet tube concentrates the flame in the center of the burner's stand—even in burners with multiple jet tubes. Heat is not distributed evenly across the bottom of the pot. Centering the pot on the burner stand is often also important—especially for large pots, which are heavy when filled. When the diameter of the pot exceeds the diameter of the stand, centering is especially important. The weight of an uncentered heavy pot is unevenly distributed on the stand, which can cause the stand and pot to tip over when the pot is filled.

A blue flame indicates complete combustion; a yellow or red flame indicates incomplete combustion. Incomplete combustion occurs when the supply of air (oxygen) is too low. The resulting yellow or red flame is at a much lower temperature than the temperature of a blue flame. So cooking time is increased, more fuel is used, and soot builds up on the bottom of the pot.

### SUMMARY

One version of an outdoor burner comprises legs and pot-support structure supported by the legs to provide a support surface on which the bottom of a pot rests at a pot-support level. A burner assembly supported by the legs or by the pot-support structure or by both includes a manifold having an inlet and at least three outlets, a gas line connected to the inlet to supply gas to the manifold, at least three nozzles, each receiving gas from a corresponding one of the at least three outlets, and at least three jet tubes, each associated with one of the at least three nozzles and having an open lower end and an opposite open upper end below the pot-support level. Each nozzle injects gas into the associated jet tube at the open lower end through which air enters. The at least three jet tubes are spaced apart from one another and configured to direct flames from their open upper ends at positions radially outward of the center of the bottom of a pot supported on the support surface.

Another version of an outdoor burner comprises legs and pot-support structure supported by the legs to provide a support surface on which the bottom of a pot rests at a pot-support level. A burner assembly supported by the legs or by the pot-support structure or by both includes a high-pressure system and a low-pressure system. The high-pressure system includes at least one jet tube with an open lower end and an opposite open upper end below the pot-support level and a first gas line configured to selectively supply gas to the lower open end of the jet tube. The low-pressure system includes a manifold having an inlet and multiple nozzles spaced apart from the at least three jet tubes and a second gas line connected to the inlet to the manifold to selectively supply gas to the manifold and the multiple nozzles. The outdoor burner also comprises an inlet gas pipe configured to deliver gas and a valve that has a first outlet connected to the first gas line and a second outlet connected to the second gas line, a valve inlet connected to the inlet gas pipe to receive gas from the inlet gas pipe, and a selector configured to selectively connect the valve inlet to the first outlet to deliver gas to the high-pressure system or to connect the valve inlet to the second outlet to deliver gas to the low-pressure system.

Yet another version of an outdoor burner comprises legs and pot-support structure supported by the legs to provide a support surface on which the bottom of a pot rests at a pot-support level. A burner assembly supported by the legs or by the pot-support structure or by both includes a high-pressure system and a low-pressure system. The high-pressure system includes at least one jet tube having an open lower end and an opposite open upper end below the pot-support level and a gas line supplying gas to the lower open end of the at least one jet tube to be mixed with air. The low-pressure system includes a low-pressure manifold having a top face through which a multiplicity of low-pressure gas nozzles are formed and an opposite bottom face having at least one opening positioned to mate with the open upper end of the at least one jet tube so that the gas mixed with air exiting the at least one jet tube is distributed to the multiplicity of low-pressure gas nozzles.

Another version of an outdoor burner comprises legs and pot-support structure supported by the legs to provide a support surface on which the bottom of a pot rests. A burner assembly supported by the legs or by the pot-support structure or by both includes at least three jet tubes spaced apart and arranged to direct flames upward from at least three corresponding jet tube positions and a flame plate supported by the legs or by the pot-support structure or by both. The flame plate includes a horizontal central base disposed in an area between the at least three jet tubes and at least three wings. Each of the wings extends obliquely upward from the base between each of the at least three jet tubes to block the flames deflected off the bottom of a pot supported on the support surface and to redirect the flames back toward the bottom of the pot.

And another version of an outdoor burner comprises a pot having a bottom with first attachment structure on the bottom, legs, and pot-support structure supported by the legs to provide a support surface on which the bottom of the pot rests. A burner assembly is supported by the legs or by the pot-support structure or by both and is arranged to direct a flame or flames upward to the bottom of the pot supported on the support surfaces. The pot-support structure includes second attachment structure on the pot-support structure releasably attached to the first attachment structure to facilitate attachment of the pot to the pot-support structure and removal of the pot from the pot-support structure.

One version of a burner assembly comprises a manifold having an inlet and at least three outlets, a gas line connected to the inlet to supply gas to the manifold, at least three nozzles, each receiving gas from a corresponding one of the at least three outlets, and at least three jet tubes, each associated with one of the at least three nozzles. The jet tubes each have an open first end admitting air into the jet tube and an opposite open second end and define a tube axis intersecting the open first and second ends. Each nozzle injects gas into the associated jet tube at the open first end on an angle oblique to the tube axis. The at least three jet tubes are spaced apart from one another.

Another version of a burner assembly comprises a nozzle and a jet tube. The nozzle has an inlet and an orifice and receives a supply of gas through the inlet and jet the gas through the orifice. The jet tube has an open first end, an opposite open second end, and a central axis intersecting the open first and second ends. The nozzle extends into the jet tube through the open first end and is arranged with the orifice positioned to jet the gas into the jet tube along an angle oblique to the central axis and at a position offset from the central axis.

### BRIEF DESCRIPTION OF THE DRAWINGS

FIGS. 1A and 1B are upper and lower views of one version of an outdoor burner embodying features of the invention.

FIG. 2 shows a propane tank, regulator, gas line, and a remote-control igniter usable with an outdoor burner as in FIGS. 1A and 1B.

FIG. 3 is a side elevation view of the outdoor burner of FIGS. 1A and 1B supporting a pot (shown open) in a centered position.

FIGS. 4A and 4B are isometric views from opposite sides of one of the centering brackets and pot supports of the outdoor burner of FIGS. 1A and 1B in a centering position.

FIG. 5 is a side elevation view as in FIG. 3, but with the centering brackets in a stowed position.

FIGS. 6A and 6B are isometric views as in FIGS. 4A and 4B, but with the centering brackets in the stowed position.

FIG. 7 is an isometric view of another version of a centering bracket usable with an outdoor burner as in FIGS. 1A and 1B.

FIGS. 8A and 8B are isometric views from opposite sides of the centering bracket of FIG. 7 in a centering position on one of the pot supports of the outdoor burner of FIGS. 1A and 1B.

FIGS. 9A and 9B are isometric views as in FIGS. 8A and 8B, but with the centering bracket in the stowed position.

FIGS. 10A and 10B are top and bottom isometric views of the burner assembly of the outdoor burner of FIGS. 1A and 1B.

FIG. 11 is a side elevation view of one of the jet tubes of the burner assembly of FIGS. 10A and 10B.

FIG. 12 is a side elevation view of another version of a jet tube with a flared inlet usable in an outdoor burner as in FIGS. 1A and 1B.

FIG. 13 is a top plan view of the outdoor burner of FIGS. 1A and 1B.

FIG. 14 is a top plan view of a flame plate usable in an outdoor burner as in FIGS. 1A and 1B.

FIGS. 15A and 15B are isometric and side elevation views of one of the jet tubes and the attached electrode assembly of the outdoor burner of FIGS. 1A and 1B.

FIGS. 16A and 16B are side elevation and top plan views of another version of an electrode assembly usable with the outdoor burner of FIGS. 1A and 1B.

FIG. 17 is an isometric view of another version of a burner assembly usable in an outdoor burner.

FIG. 18 is an isometric view of an outdoor burner as in FIGS. 1A and 1B with a removable low-pressure burner manifold.

FIG. 19 is an isometric bottom view of the low-pressure burner manifold in FIG. 18.

FIG. 20 is an isometric view of an outdoor burner with a single jet tube and a removable low-pressure burner manifold.

FIG. 21 is an isometric view of a version of a burner assembly with alternately selectable low-and high-pressure burners.

FIG. 22 is a side elevation view of the burner assembly of FIG. 21 in a portion of an outdoor burner as in FIGS. 1A and 1B.

FIG. 23 is an isometric view of an outdoor burner with attachments for attaching to the bottom of a pot with mating attachments.

FIG. 24 is an isometric view as in FIG. 23 with the pot attached to the outdoor burner assembly.

### DETAILED DESCRIPTION

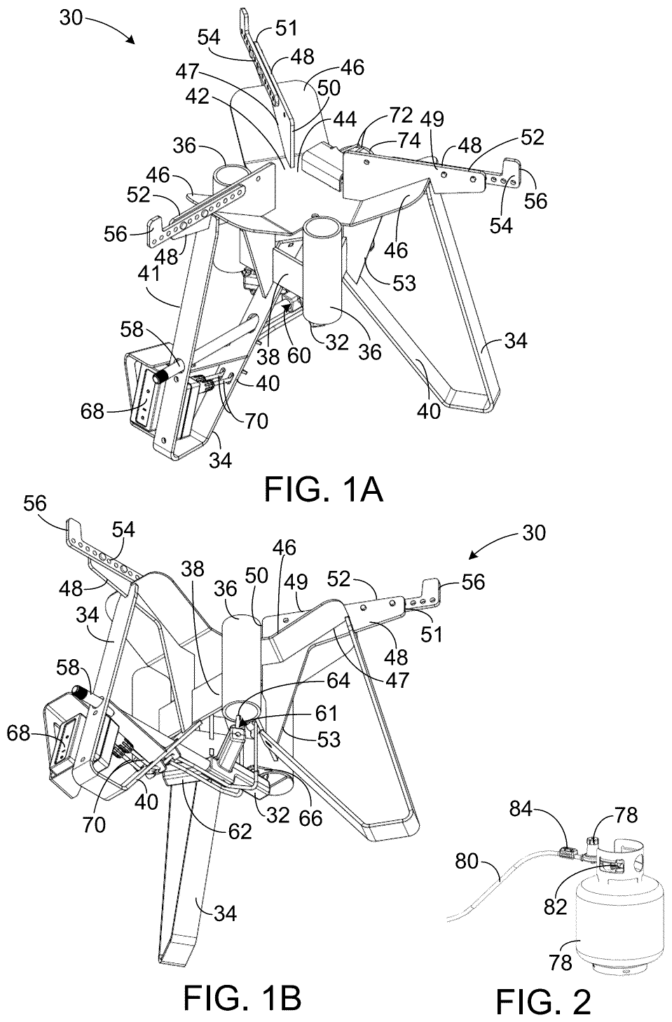

One version of an outdoor burner is shown in FIGS. 1A and 1B. The exemplary outdoor burner 30 is constructed of a burner assembly 32 mounted on three legs 34. The burner assembly is shown with three jet tubes 36 out of which flames shoot. But the burner assembly could be constructed of more or fewer than three jet tubes 36. The three jet tubes 36 are connected to each other at spaced apart locations by connector plates 38. The connector plates 38 are supported on inner branches 40 of the legs 34. A flame plate 42 is also supported by the legs 34 directly or indirectly. The flame plate has a horizontal central base 44 disposed in an area between the jet tubes 36. The flame plate 42 has three wings 46 that extend obliquely upward from the central base 44 between each of the jet tubes 36 to block flames deflected off the bottom of a pot supported on the burner 30 and to redirect those flames back toward the bottom of the pot.

Three pot supports 48 circumferentially spaced apart from each other are supported by the legs 34 and the wings 46 of the flame plate 42. Each pot support 48 is in the shape of an inverted L with a horizontal arm 49 having a support surface on a top edge 52 and with a vertical arm 53. There could be more than three pot supports 48. The pot supports 48 extend radially outward of the center of the burner 30 from an inner end 50 of the horizontal arm 49 to an outer end 51. The pot supports 48 extend through slits 47 in the wings 46 of the flame plate 42. The vertical arm 53 is welded to one of the connector plates 38 or to one of the legs 34 or to both. The horizontal arm 49 could be welded to the wing 46. The pot supports 48 form pot-support structure providing the support surface on the top edge 52 of each pot support for a cooking pot. In this example the pot supports 48 are stainless-plate fins. But round bar bent to form each leg and pot support unitarily could be used instead, or round bar could be welded atop fins. Centering brackets 54 attached to each of the pot supports 48 have upstanding stops 56 at each distal end that extend above the pot-support level of the support surface. The centering brackets 54 are attachable to side faces of the pot supports 48 at selectable positions to position the stops at selectable distances from the inner ends 50 of the pot supports. Thus, by limiting the radial excursion of supported pots, the stops 56 can be used to center the pots on the support surface relative to the jet tubes 36.

A gas line 58, such as a pipe, extends through both the inner and outer branches 40, 41 of the legs 34 to the inlet 60 of a manifold 62. Or the pipe could be routed around the leg. The manifold 62 has three outlets 61, each feeding gas to a nozzle 64 that extends obliquely upward into a jet tube 36. The manifold 62 is fastened to tabs 66 extending inwardly from the jet tubes 36.

An electronic ignition unit 68 attached to one of the legs 34 has wiring 70—two wires in this example—connecting it to two electrodes 72 supported in an electrode assembly. Distal ends of the electrodes 72 extend above an open upper end 74 of one of the jet tubes 36. But they could extend down into the jet tubes 36. The ignition unit 68 produces high-voltage pulses that generate arcs to ignite the gas flowing up the jet tube 36. The resulting flame spreads across the bottom of a supported pot to ignite the gas flowing up the other two jet tubes 36.

Gas, such as propane, is supplied to the burner from a tank 76, as shown in FIG. 2. A regulator 78 in a gas line 80 that runs from the tank's valve 82 to the burner's gas pipe 58 (FIGS. 1A and 1B) is used to adjust the supply of gas. A user-operated remote controller 84 shown attached to the gas line 80 near the regulator 78 can be used to send a wireless signal to a receiver in the ignition unit 68 (FIGS. 1A and 1B) to cause the ignition unit to produce the high-voltage pulses at the electrodes 72 that generate the arcs to ignite the gas mixed with air. The remote controller 84 can be held in the user's hand rather than attached to the gas line 80. Alternatively, the user can ignite the flame locally from the ignition unit 68 itself. Details of an ignition unit, an electrode assembly, and a remote controller usable in the burner are described in U.S. patent application Ser. No. 18/092,721, “Burner Igniter,” filed Jan. 3, 2023, and published on Jul. 4, 2024, under Publication No. 2024/-219025A1. The disclosure of that patent application is incorporated into this application by reference.

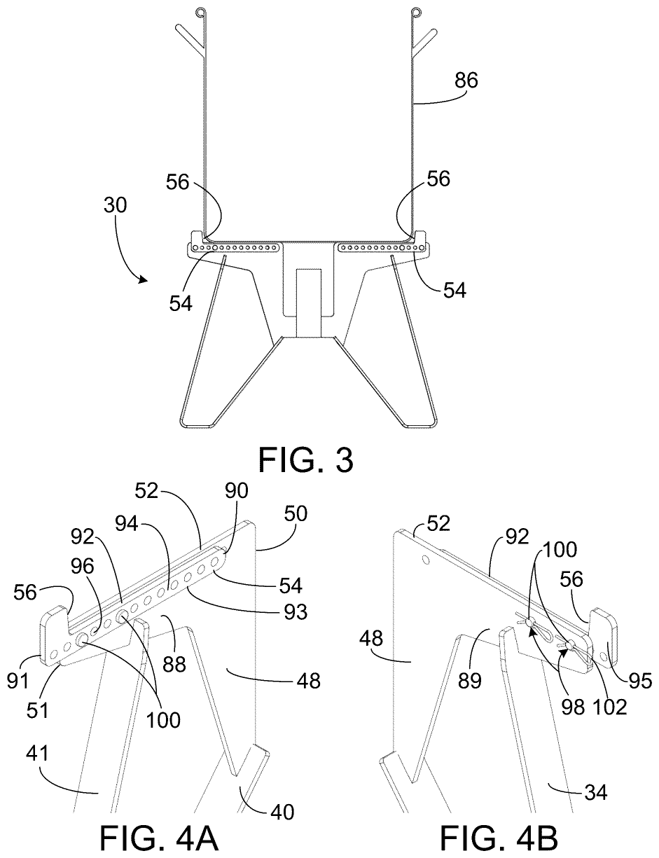

Further details of the centering brackets 54 are shown in FIGS. 3-6B. In FIG. 3 the centering brackets 54 are shown in the centering position centering a pot 86 atop the outdoor burner 30. The upstanding stops 56 at the radially outer ends of the brackets 54 prevent the pot 86 from moving radially outward. When all three centering brackets 54 are adjusted so that their stops 56 are equi-distant from the inner ends 50 of the associated pot supports 48 and just beyond the circumference of the bottom of the pot 86, they effectively maintain the pot centered in the burner 30.

Details of the adjustment of the centering brackets 54 are given in reference to one of the brackets as shown in FIGS. 4A and 4B. The pot support 48 is supported by the inner and outer branches 40, 41 of one of the legs 34. The pot support 48 extends radially outward from its inner end 50 to its outer end 51 and in thickness from a first side 88 to an opposite second side 89. The centering bracket 54 extends in length from a first end 90 to a second end 91, in width from a first edge 92 to a second edge 93, and in thickness from a first face 94 to an opposite second face 95. An increased step in the width of the bracket 54 at the second end 91 forms the raised stop 56. The second face 95 abuts the first side of the pot support 48. Positioning holes 96 extending from the first face 94 to the second face 95 form a line along the length of the centering bracket 48. A selected pair of the positioning holes 96 are aligned with two mounting holes 98 in the pot support 48 to position the bracket's upstanding stop 56 at the appropriate centering distance for the pot. Dowel pins 100 are inserted through the aligned positioning and mounting holes 96, 98 and retained in place by cotter pins 102 through holes in the dowel pins at the second side 89 of the pot support 48. In the bracket's centering position, the raised stop 56 protrudes above the pot support's top edge 52—the pot's support surface.

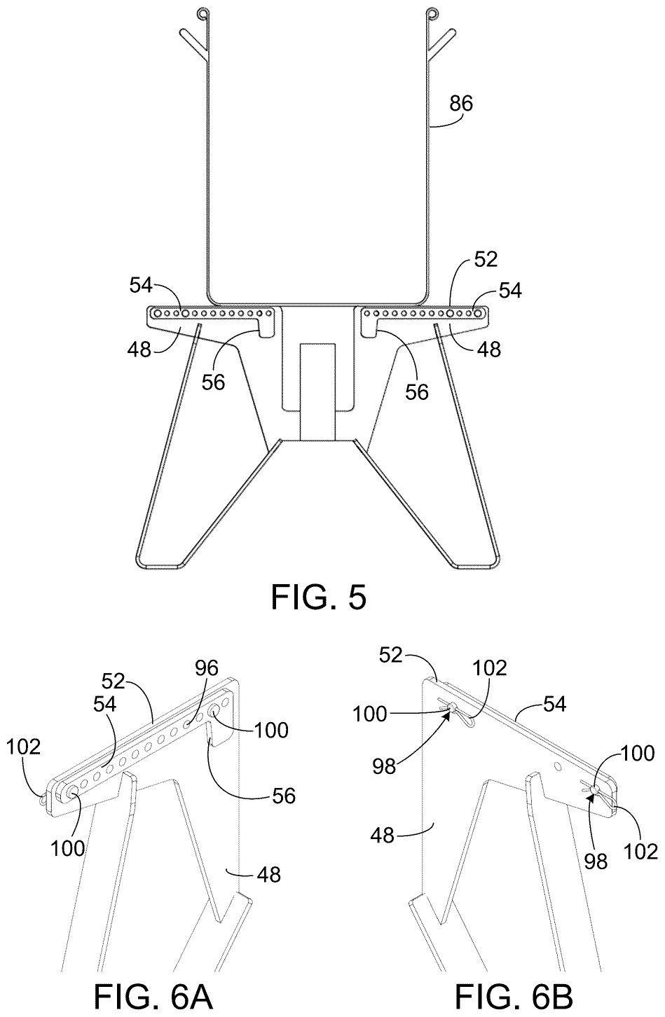

FIG. 5 shows a pot 86 sitting atop the burner's pot supports 48 with the centering brackets 54 in stowed positions, in which the stops 56 extend downward below the top edges 52 of the pot supports. As shown in FIGS. 6A and 6B, the centering bracket 54 is stowed with its stop 56 below the top support edge 52 of the pot support 48. Two of the bracket's positioning holes 96 are aligned with two mounting holes 98 through the pot support 48. The dowel pins 100 extend through the aligned positioning and mounting holes 96, 98 and are retained in place by cotter pins 102.

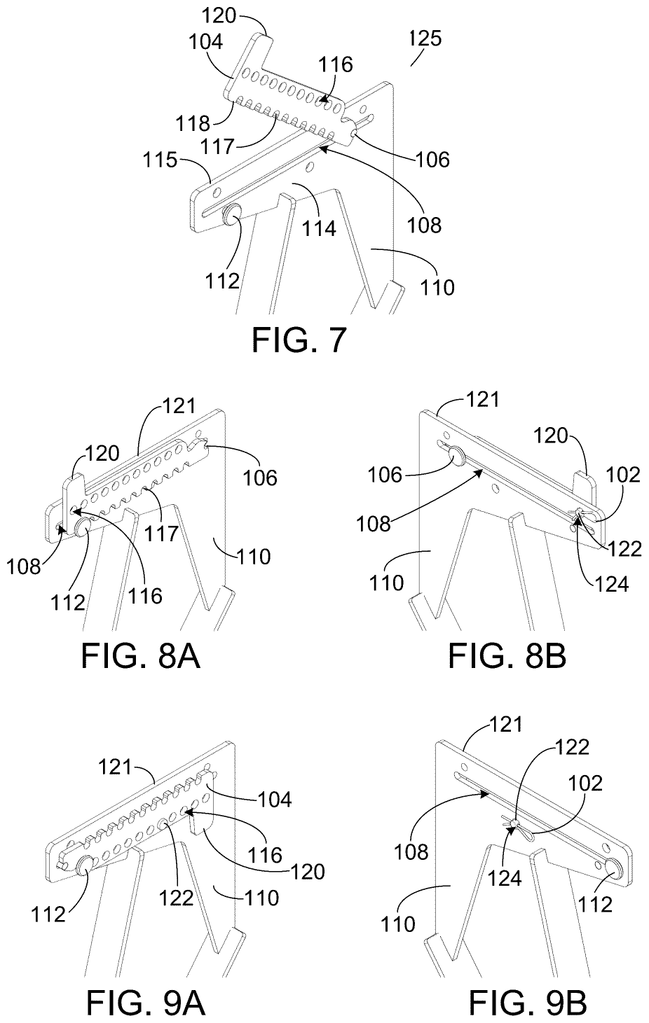

Another version of a centering bracket usable with an outdoor burner as in FIGS. 1A and 1B is shown in FIG. 7. In this version the centering bracket 104 includes a pivot pin 106 that is received in a slot 108 through the thickness of a pot support 110. A positioning dowel 112 with an enlarged head extends outward of a first face 114 of the pot support 110. The centering bracket 104 has two lines of positioning holes 116, 117 that extend along the length of the bracket. The positioning holes 116, 117 extend through the bracket's thickness from the first face 114 to an opposite second face 115. The positioning holes 117 along a first edge 118 of the centering bracket 104 open onto the first edge to form detents. Thus, the positioning holes 117 are not closed holes. Like the centering bracket of FIG. 3, the centering bracket 110 has a raised stop 120 at one end.

FIGS. 8A and 8B show the centering bracket 104 in the centering position. The bracket's pivot pin 106 is slid along the slot 108 until the raised stop 120 is positioned above the pot support's top edge 121 appropriately for the size of the pot to be used. Then the bracket 104 is pivoted so that one of the detents 117 rests on the positioning dowel 112. Another dowel 122 is inserted through one of the positioning holes 116 in the other line through a mounting hole 124 in the pot support 110. A cotter pin 102 through the end of the dowel 122 holds it in place.

FIGS. 9A and 9B show the centering bracket 104 in the stowed position. The pivot pin 106 is positioned at the radially outer end of the slot 108 with the stop 120 facing downward at the other end of the bracket 104 below the pot support's top edge 121. A dowel pin 122 inserted in aligned positioning and mounting holes 116, 124 and retained by a cotter pin 102 holding the centering bracket 104 in position against the pot support 110. A notch 125 (FIG. 7) in the bracket 104 rests on the positioning dowel 112.

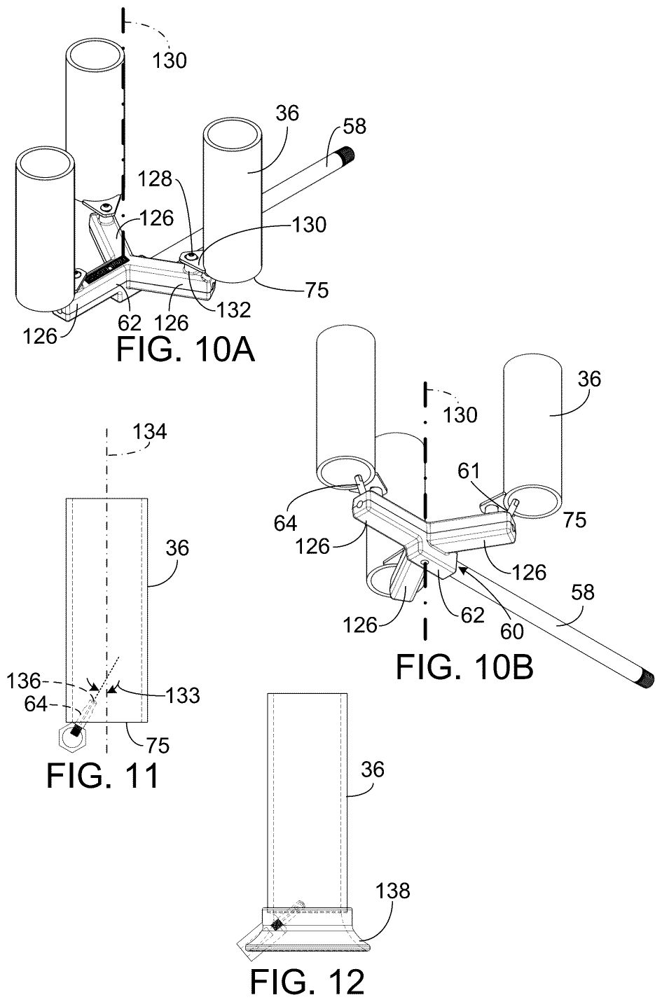

A portion of a burner assembly for the outdoor burner of FIGS. 1A and 1B is shown in FIGS. 10A and 10B. The gas line 58 extends into the inlet 60 of the manifold 62. The manifold has three branches 126 that terminate in the outlets 61 from which the nozzles 64 extend obliquely into open bottom ends 75 of the jet tubes 36. Screws or bolts 128 extend through tabs 130 at the bottom outer side of the jet tubes 36 and through spacers 132 between the tabs and the branches 126 of the manifold 62 to fasten the jet tubes to the manifold. The three jet tubes 36, manifold branches 126, and nozzles 64 are spaced apart from and symmetrically arranged about a central axis 130 of the burner assembly.

As shown in FIG. 11, the nozzle 64 is arranged to inject gas into the jet tube 36 at an oblique angle 133 relative to the cylindrical tube's central axis 134. The nozzle's orifice 136 is offset from the tube's central axis 134 so as to minimize the blockage of air entering through the open bottom end 75 of the tube 36 for more complete combustion of the gas. The jet tube 36 is shown in FIG. 12 with a conical collar 138 that flares outward at the bottom of the tube to gather even more air into the tube.

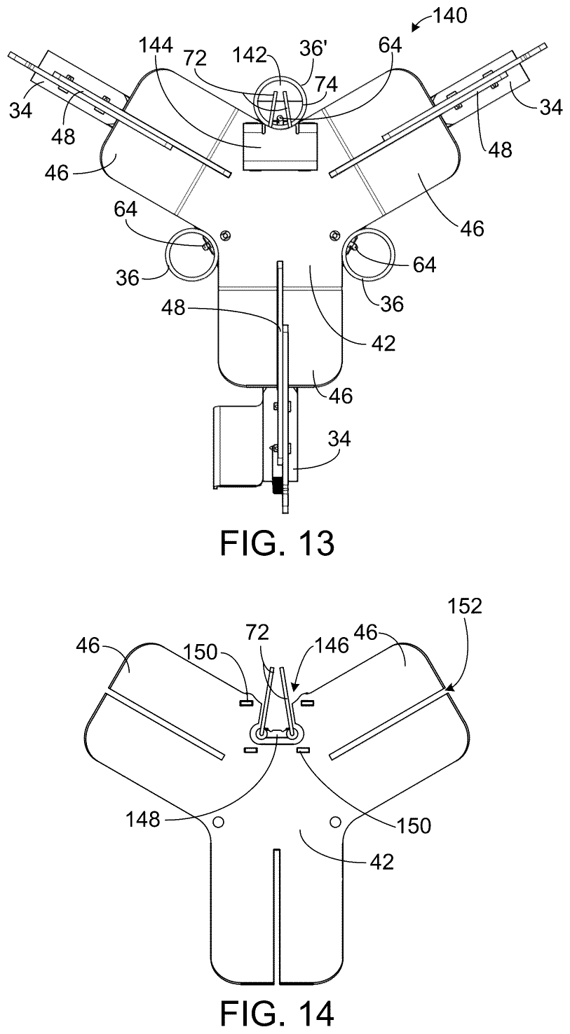

The top plan view of the burner assembly 140 in FIG. 3 shows the symmetrical arrangement of the three-jet burner 30. The legs 34, the pot supports 48, and the wings 46 of the flame plate 42 are spaced apart circumferentially by 120°. And the jet tubes 36 and nozzles 64 are also equi-spaced apart by 120° on angles bisecting the angles of the legs 34, the pot supports 48, and the wings 46. FIG. 13 also shows that only one of the jet tubes 36′ has the igniter electrode 72 extending over the tube's open end 74. To aid initial ignitions of the gas, an occlusion 142 at the open bottom end of the jet tube 36′ reduces the amount of air drawn into the tube. The flame exiting the jet tube 36′ spreads along the bottom of a pot resting on the pot supports 48 and ignites the gas flowing through the other two tubes 36. A shield 144 covering the electrode assembly protects it from flames.

FIG. 14 shows the flame plate 42. The electrodes 72 of an electrode assembly 148 extend through an opening 146 in the flame plate 42 in the crotch between the two wings 46 flanking the igniter jet tubes (36′, FIG. 13). Four slots 150 around the opening 146 receive four feet of the electrode shield (144, FIG. 13). Radially extending slots 152 in the wings 46 receive the pot supports (48, FIG. 13).

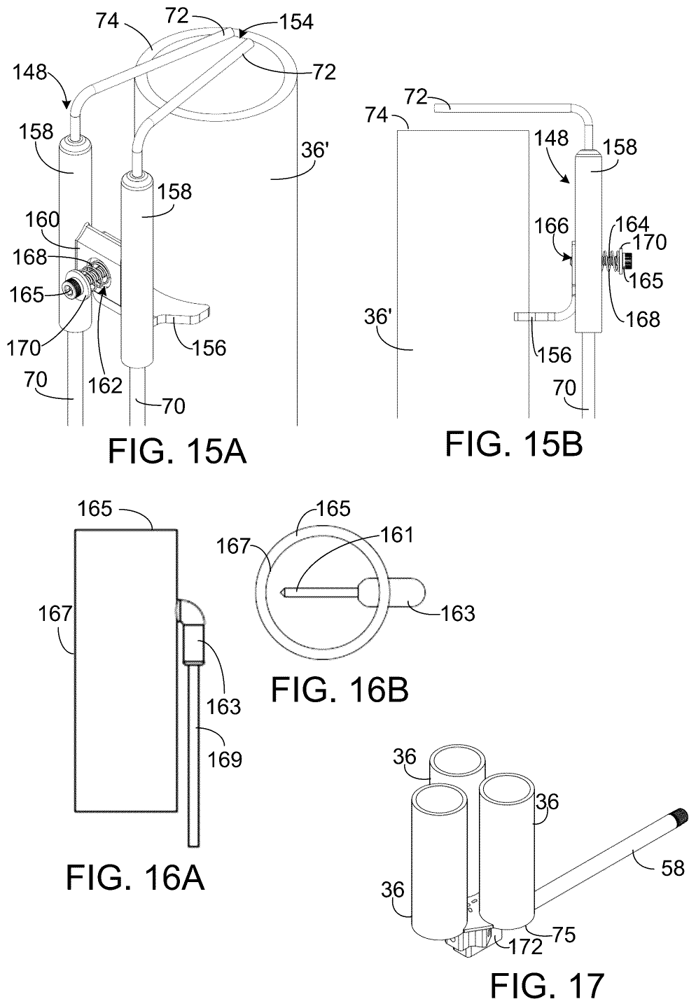

Further details of the electrode assembly 148 are shown in FIGS. 15A and 15B. The assembly 148 is composed of two electrodes 72 whose distal ends extend across and above the open upper end 74 of the jet tube 36′. The distal ends could alternatively be bent to extend down into the jet tube. The distal ends are separated by a spark gap 154 in which an arc is generated when the voltage between the electrodes 72 is high enough. An electrode mount 156 extends from the outside of the jet tube 36′. Ceramic insulators 158 surround the electrodes 74 and their connection to the wires 70 from the ignition unit. A connection plate 160 attached at opposite ends to the two insulators 158 has a central hole 162 through which the shaft 164 of a bolt 165 extends into threaded engagement with a threaded hole 166 in the electrode mount 156. A spring 168 surrounding the bolt's shaft 164 between the connection plate 160 and a washer 170 at the bolt's head biases the electrode assembly 148 toward the jet tube 36′ with enough compliance to provide the electrode assembly with play as the burner assembly expands and contracts with temperature. The electrode assembly 148 is shown with two electrodes 72 but could be made with a single electrode capable of arcing to the jet tube electrically connected to one of the wires from the ignition unit. One example of that is shown in FIGS. 16A and 16B. An electrode 161 of an electrode assembly 163 is inserted into a jet tube 165 through a hole in the tube's wall 167. An arc is formed between the electrode 161 and the nearby wall 167 to ignite the gas.

A burner-unit arrangement of three jet tubes 36 in a tighter spaced-apart configuration is shown in FIG. 17. Gas is emitted into the jet tubes 36 through nozzles as described with respect to FIG. 11. The nozzles extend into the open lower ends 75 of the jet tubes 36 from a manifold 172 with shorter branches than the manifold 62 of FIGS. 10A and 10B. Gas is fed into the manifold 172 through the gas pipe 58. The tighter jet-tube configuration is useful for small-diameter pots.

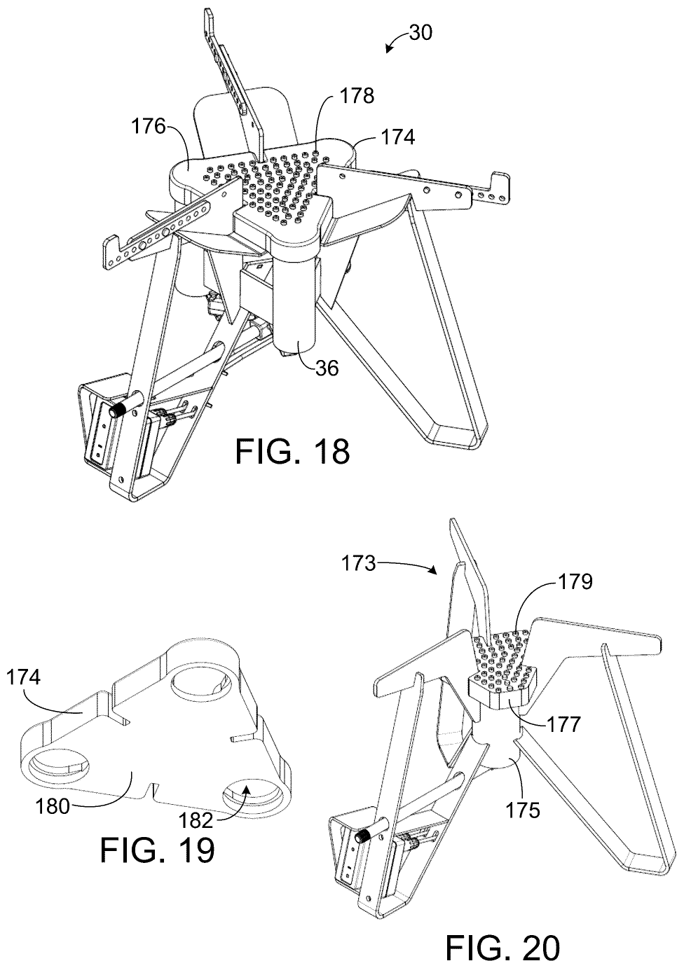

The burner assemblies described thus far are high-pressure cooking systems. Sometimes high-pressure cooking is not desirable. FIGS. 18 and 19 show a removable attachment to the outdoor burner 30 that adapts it to a low-pressure cooking system. The attachment is a low-pressure manifold 174 having a top face 176 through which a multiplicity of low-pressure gas nozzles 178 are formed. The low-pressure manifold 174 has an opposite bottom face 180 with three openings 182 arranged to mate with the open upper ends of the three jet tubes 36. The gas mixed with air exiting the jet tubes 36 is distributed in the manifold 174 to the multiplicity of low-pressure nozzles 178. The input nozzles of one or more of the jet tubes 36 or one or more of the openings 182 into the low-pressure manifold 174 can be blocked by appropriate blocking structure for reduced heat intensity. In FIG. 20 an outdoor burner 173 with a single jet tube 175 has a removable low-pressure manifold 177 with a single central opening on the bottom that mates with the jet tube to receive the gas-air mixture for distribution to low-pressure nozzles 179.

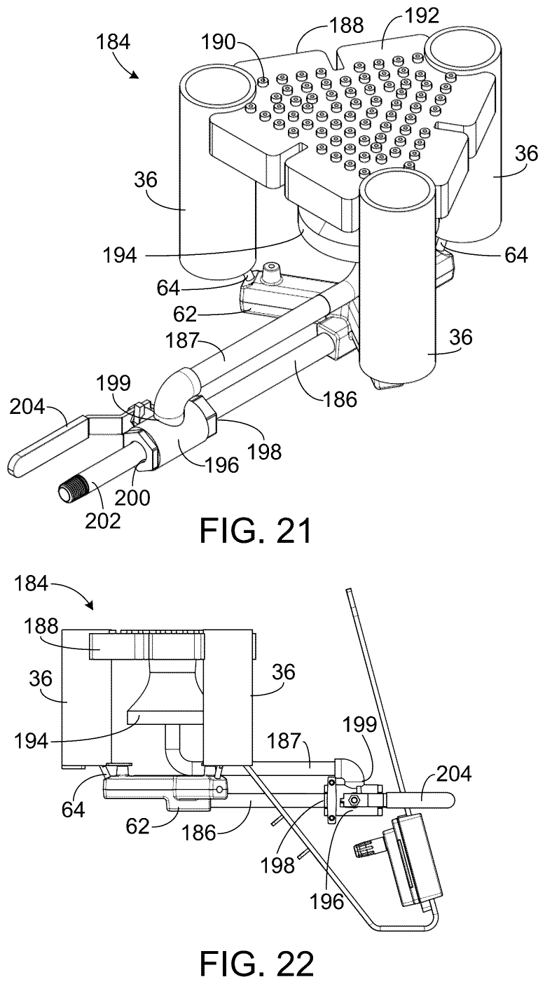

An outdoor burner having a burner assembly 184 as in FIGS. 21 and 22 can be operated as either a low-pressure or a high-pressure cooking system. The high-pressure system includes a first gas line 186 feeding gas into the high-pressure manifold 62, which supplies gas to the jet tubes 36 through the nozzles 64. The low-pressure system includes a second manifold 188 attached to the jet tubes 36. Multiple nozzles 190, spaced apart from the jet tubes 36, extend through the second manifold's flat top surface 192. An inlet 194 at the bottom of the second manifold 188 receives gas from a second gas line 187. A valve 196 has a first outlet 198 connected to the first gas line 186 and a second outlet 199 connected to the second gas line 187. Gas is supplied to the valve 196 through an inlet 200 by a gas pipe 202. A selector in the form of a selector handle 204 is used to manually switch the valve's output between the first outlet 198 for high-pressure cooking and the second outlet 199 for low-pressure cooking. The selector could alternatively be an electronic switch locally or remotely operated.

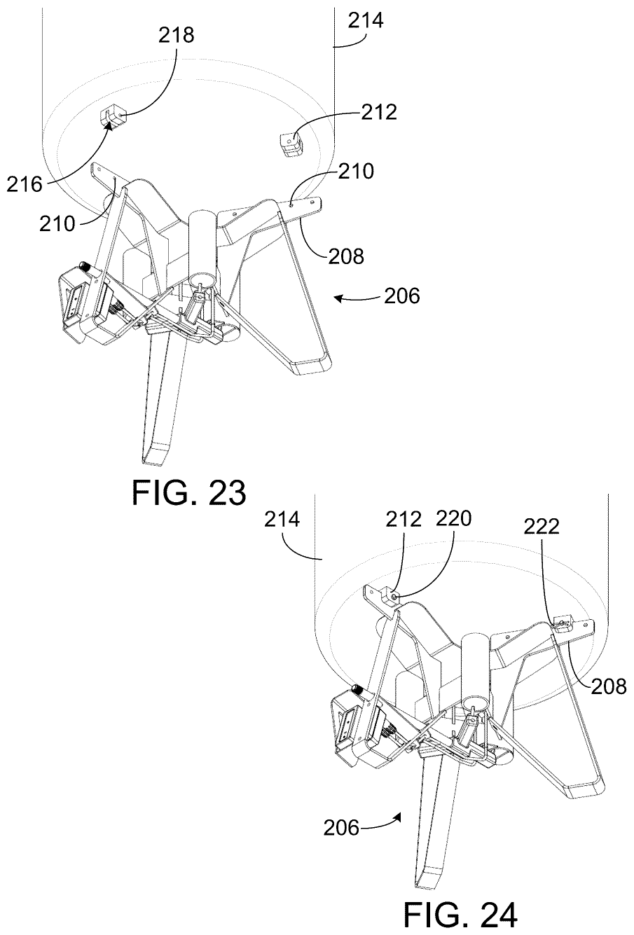

Another version of an outdoor burner is shown in FIGS. 23 and 24. The outdoor burner 206 differs from the burner of FIGS. 1A and 1B in that it lacks centering brackets. Instead, its pot supports 208 have mounting holes 210 as attachment structure that mates with attachment structure 212 on the bottoms of pots 214. The first attachment structure 212 on the pot 214 are blocks with a central radial slit 216. The slits 216 receive the pot supports 208 atop which the pot 214 sits. The mounting holes 210 in the pot supports 208 align with mounting holes 218 through the pot's mounting blocks 212. Dowel pins 220 inserted in the aligned holes 210, 218 and retained by cotter pins 222 releasably attach the pot 214 to the burner 206 in a centered position. If pot supports different from those shown in the exemplary burners are used, the first attachment structure on the bottom of the pot would correspondingly differ to match the pot-support structure.

The legs 34, pot supports 48, flame plate 42, connector plates 38, and jet tubes 36 are all made of thin stainless steel fitted together and welded or bolted at various attachment points. But some or all of those parts may be made of other materials.

Although only a few versions of outdoor burners and burner assemblies have been described, other versions are possible. For example, more than three jet tubes, nozzles, manifold outlets, pot supports, legs, and flame-plate wings can be made. As another example, electrodes could be installed at each jet tube instead of only one. Of course, the jet tubes and the low-pressure nozzles can be ignited by a match or hand-held lighter.

What is claimed is:

1. An outdoor burner comprising:
pot-support structure configured to provide a support surface on which the bottom of a pot rests at a pot-support level;
a burner assembly including:
a manifold having an inlet and at least three outlets;
a gas line connected to the inlet to supply gas to the manifold;
at least three nozzles, each receiving gas from a corresponding one of the at least three outlets;
at least three jet tubes, each associated with one of the at least three nozzles and having an open lower end and an opposite open upper end below the pot-support level;
wherein each nozzle injects gas into the associated jet tube at the open lower end through which air enters;
wherein the at least three jet tubes are spaced apart from one another and configured to direct flames from their open upper ends at positions radially outward of the center of the bottom of a pot supported on the support surface.

2. The outdoor burner of claim 1 comprising legs supporting the pot-support structure and wherein the burner assembly is supported by the legs or by the pot-support structure or by both.

3. The outdoor burner of claim 1 wherein the pot-support structure comprises three pot supports extending radially outward from inner ends to outer ends along different angles and having top edges forming the support surface.

4. The outdoor burner of claim 3 wherein the burner assembly comprises three jet tubes, three nozzles, and three outlets and wherein the outdoor burner comprises a flame plate supported by the legs and including a horizontal central base disposed in an area between the three jet tubes.

5. The outdoor burner of claim 4 wherein the burner assembly includes three wings extending obliquely upward from the central base between each of the three jet tubes to block the flames deflected off the bottom of a pot supported on the support surface and to redirect the flames back toward the bottom of the pot.

6. The outdoor burner of claim 3 comprising three centering brackets, each adjustably attached to a corresponding one of the three pot supports and having a stop that extends above the pot-support level and whose distance from the inner end of the corresponding pot support can be adjusted in a centering position to center the pot relative to the burner.

7. The outdoor burner of claim 6 wherein the three centering brackets are movable from the centering position to a stowed position in which the stops are below the pot-support level.

8. The outdoor burner of claim 1 comprising:
an electrode assembly attached to one of the jet tubes and including an electrode having a distal end;
an ignition unit;
wiring electrically connecting the electrode to the ignition unit;
wherein the distal end of the electrode extends into the jet tube or above the open upper end of the jet tube to which the electrode assembly is attached;
wherein the ignition unit produces a high voltage at the electrode to generate an arc that ignites the gas mixed with air to produce a flame exiting the upper end of the jet tube.

9. The outdoor burner of claim 8 comprising a user-operated remote controller selectively sending a wireless signal and wherein the ignition unit includes a receiver configured to receive the wireless signal and produce the high voltage at the electrode to generate the arc.

10. The outdoor burner of claim 8 comprising an electrode mount attached to the jet tube, a shaft extending from the electrode mount through the electrode assembly, and a spring around the shaft biasing the electrode assembly toward the jet tube with enough compliance to provide the electrode assembly with play as the burner assembly expands and contracts with temperature.

11. The outdoor burner of claim 8 wherein the burner unit includes an occlusion partly occluding the open lower end of the jet tube attached to the electrode assembly to reduce the amount of air drawn into the jet tube so that the electrode's arc can ignite the gas.

12. The outdoor burner of claim 1 wherein the at least three jet tubes each define a tube axis intersecting the upper and lower ends and wherein each nozzle injects gas into the associated jet tube at the open lower end on an angle oblique to the tube axis.

13. The outdoor burner of claim 1 comprising:
a pot having a bottom and first attachment structure on the bottom;
wherein the pot-support structure includes second attachment structure on the pot-support structure releasably attached to the first attachment structure to facilitate attachment of the pot to the pot-support structure and removal of the pot from the pot-support structure.

14. An outdoor burner comprising:
legs;
pot-support structure configured to provide a support surface on which the bottom of a pot rests at a pot-support level;
a burner assembly supported by the legs or by the pot-support structure or by both and including:
a high-pressure system including:
at least one jet tube having an open lower end and an opposite open upper end below the pot-support level;
a first gas line configured to selectively supply gas to the lower open end of the jet tube;
a low-pressure system including:
a first manifold having an inlet and multiple nozzles spaced apart from the at least three jet tubes;
a second gas line connected to the inlet to the first manifold to selectively supply gas to the first manifold and the multiple nozzles;
an inlet gas pipe configured to deliver gas;
a valve having;
a first outlet connected to the first gas line and a second outlet connected to the second gas line;
a valve inlet connected to the inlet gas pipe to receive gas from the inlet gas pipe;
a selector configured to selectively connect the valve inlet to the first outlet to deliver gas to the high-pressure system or to connect the valve inlet to the second outlet to deliver gas to the low-pressure system.

15. The outdoor burner of claim 14 wherein the high-pressure system comprises:
a second manifold having an inlet and at least three outlets, wherein the first gas line is connected to the inlet of the second manifold;
at least three nozzles, each receiving gas from a corresponding one of the at least three outlets;
at least three jet tubes, each associated with one of the at least three nozzles and having the lower open end and an opposite upper open end below the pot-support level;
wherein each of the at least three nozzles injects gas into the associated jet tube at the open lower end.

16. The outdoor burner of claim 14 wherein the first manifold has a flat top surface through which the multiple nozzles extend and wherein the first manifold is supported between the at least three jet tubes.

17. An outdoor burner comprising:
legs;
pot-support structure configured to provide a support surface on which the bottom of a pot rests at a pot-support level;
a burner assembly supported by the legs or by the pot-support structure or by both and including:
a high-pressure system including:
at least one jet tube having an open lower end and an opposite open upper end below the pot-support level;
a gas line supplying gas to the lower open end of the at least one jet tube to be mixed with air;
a low-pressure system including a low-pressure manifold having a top face through which a multiplicity of low-pressure gas nozzles are formed and an opposite bottom face having at least one opening positioned to mate with the open upper end of the at least one jet tube so that the gas mixed with air exiting the at least one jet tube is distributed to the multiplicity of low-pressure gas nozzles.

18. The outdoor burner of claim 17 wherein the high-pressure system has a single jet tube and the low-pressure manifold has a single opening centered on the bottom face to mate with the open upper end of the single jet tube.

19. The outdoor burner of claim 17 wherein the high-pressure system includes three jet tubes and wherein the low-pressure manifold includes three openings in the bottom face positioned to mate with the open upper ends of the at least three jet tubes so that the gas mixed with air exiting the at least three jet tubes is distributed to the multiplicity of low-pressure gas nozzles.

20. An outdoor burner comprising:
legs;
pot-support structure configured to provide a support surface on which the bottom of a pot rests;
a burner assembly supported by the legs or by the pot-support structure or by both and including at least three jet tubes spaced apart and arranged to direct flames upward from at least three corresponding jet tube positions;
a flame plate supported by the legs or by the pot-support structure or by both and including:
a horizontal central base disposed in an area between the at least three jet tubes.

21. The outdoor burner of claim 20 comprising at least three wings, each extending obliquely upward from the base between each of the at least three jet tubes to block the flames deflected off the bottom of a pot supported on the support surface and to redirect the flames back toward the bottom of the pot.

22. The outdoor burner of claim 21 wherein the at least three pot supports extend upward from the at least three wings.

23. The outdoor burner of claim 20 comprising:
an electrode assembly attached to one of the jet tubes and including an electrode having a distal end;
wherein the at least three jet tubes each have an open lower end and an open upper end;
wherein the horizontal central base of the flame plate has an opening;
wherein the electrode assembly extends through the opening with the distal end of the electrode positioned into the jet tube or above the open upper end of the jet tube to which the electrode assembly is attached.

24. The outdoor burner of claim 23 comprising an electrode mount attached to the jet tube, a shaft extending from the electrode mount through the electrode assembly, and a spring around the shaft biasing the electrode assembly toward the jet tube with enough compliance to provide the electrode assembly with play as the burner assembly expands and contracts with temperature.

25. The outdoor burner of claim 23 wherein the electrode extends into the jet tube through a hole in the jet tube between the open upper and lower ends.

26. The outdoor burner of claim 20 wherein the pot-support structure includes at least three pot supports extending radially outward from inner ends to outer ends along different angles and having top edges forming the support surface.

27. An outdoor burner comprising:
legs;
at least three circumferentially spaced apart pot supports extending radially outward from an inner end to an outer end and in thickness first side to a second side, each of the at least three pot supports having:
an upper support surface configured to support the bottom of a pot;
mounting holes extending through the thickness from the first side to the second side;
a burner assembly supported by the legs or by the pot supports or by both and arranged to direct a flame or flames upward to the bottom of a pot supported on the support surfaces;
a centering bracket associated with at least three of the at least three pot supports, each centering bracket extending in length from a first end to a second end, in width from a first edge to a second edge, and in thickness from a first face to a second face and including:
a plurality of positioning holes extending through the thickness from the first face to the second face and arranged in a line along the length of the centering bracket;
dowel pins associated with the mounting holes;
wherein selected positioning holes are aligned with the mounting holes to receive the dowel pins to retain the centering bracket in position with the raised stop at the selected radial position above the pot support's upper support surface to block a pot supported on the pot support's upper support surface from moving radially outward past the stop.

28. The outdoor burner of claim 27 wherein the positioning holes open onto the second edge of the centering bracket to form detents.

29. The outdoor burner of claim 27 wherein the centering bracket includes an increased step in the width of the centering bracket at the second end forming a raised stop.

30. The outdoor burner of claim 29 wherein each of the pot supports includes a slot extending radially along the pot support below the support surface and wherein the associated centering bracket includes a pivot pin at the first end received in the slot, wherein the pivot pin is slidable along the slot to position the raised stop of the centering bracket at a selected radial position and wherein the centering bracket is pivotable about the pivot pin to rotate the centering bracket to position the centering bracket in a centering position with the raised stop at the selected radial position above the pot support's support surface to block a pot supported on the pot support's support surface from moving radially outward past the stop.

31. The outdoor burner of claim 29 wherein the centering brackets are pivotable about the pivot pins from the centering position to a stowed position in which the stops are below the pot supports' support surfaces.

32. A burner assembly comprising:
a manifold having an inlet and at least three outlets;
a gas line connected to the inlet to supply gas to the manifold;
at least three nozzles, each receiving gas from a corresponding one of the at least three outlets;
at least three jet tubes, each associated with one of the at least three nozzles and having an open first end admitting air into the jet tube and an opposite open second end and defining a tube axis intersecting the open first and second ends;
wherein each nozzle injects gas into the associated jet tube at the open first end on an angle oblique to the tube axis;
wherein the at least three jet tubes are spaced apart from one another.

33. The burner assembly of claim 32 wherein the at least three jet tubes comprise exactly three jet tubes equi-spaced from each other.

34. The burner assembly of claim 32 comprising an electrode having a distal end positioned over or down through the open second end of one of the at least three jet tubes to generate an arc to ignite the gas injected into the jet tube.

35. The burner assembly of claim 32 comprising an electrode and wherein one of the at least three jet tubes has a wall surrounding a jet-tube interior and having a hole through which the electrode extends into the jet-tube interior to generate an arc to ignite the gas injected into the jet tube.

36. The burner assembly of claim 32 wherein each nozzle has an orifice spaced apart from the tube axis and through which the gas is injected into the jet tube.

37. The burner assembly of claim 32 comprising a flame plate including:
a horizontal central base disposed in an area between the at least three jet tubes; and
at least three wings, each extending obliquely upward from the base between each of the at least three jet tubes.

38. The burner assembly of claim 32 comprising a low-pressure manifold that includes a top face through which a multiplicity of low-pressure gas nozzles are formed and an opposite bottom face having at least three openings positioned to mate with the open second ends of the at least three jet tubes so that the gas mixed with air exiting the at least three jet tubes is distributed to the multiplicity of low-pressure gas nozzles.

39. The burner assembly of claim 38 wherein one or more of the at least three openings or one or more of the at least three nozzles can be blocked to reduce heat intensity.
